(19) United States
(12) Patent Application Publication
(10) Pub. No.: US 2026/0290878 A1
(43) Pub. Date: Sep. 24, 2026

(54) HYDROSTATIC SOLID-STATE BATTERY CELL CONSTRAINT SYSTEMS

(71) Applicant: Ford Global Technologies, LLC, Dearborn, MI (US)

(72) Inventors: Andrew Robert Drews, Ann Arbor, MI (US); Xin Liu, Novi, MI (US)

(21) Appl. No.: 19/084,528

(22) Filed: Mar. 19, 2025

(51) Int. Cl. H01M 10/04; B60L 50/60; H01M 50/204; H01M 50/262

(52) U.S. Cl. CPC H01M 10/0468; H01M 50/204; H01M 50/262; B60L 50/60; H01M 2220/20

(57) ABSTRACT

Hydrostatic constraint devices are provided herein for applying substantially uniform pressure on electrode stacks or arrays. In one example approach, a battery cell constraint system is provided that comprises a battery cell stack; a first endplate positioned over a first face of the stack; a second endplate positioned over a second face of the stack, where the first face opposes the second face; a first chamber filled with hydraulic fluid between the first endplate and a first flexible membrane above the first face of the stack; and a second chamber filled with hydraulic fluid between the second endplate and a second flexible membrane above the second face of the stack.

### TECHNICAL FIELD

The present disclosure relates to solid-state batteries.

### BACKGROUND AND SUMMARY

Solid-state batteries may use metallic lithium for the anode and oxides or sulfides for the cathode, thereby increasing energy density. The solid electrolyte may act as a separator that allows only lithium ions to pass through. Solid-state batteries may be used in a variety of devices and machines including, but not limited to, consumer electronics applications, pacemakers, RFID and wearable devices, and electric or hybrid electric vehicles, for example.

Solid state battery cells, e.g., solid-state lithium-ion battery cells, may use constraint systems to apply forces normal to the electrode stacking planes. Such constraint systems may be used to ensure close contact between electrodes and separators during use to maintain power and cycle life capability.

Hydrostatic constraint devices are provided herein for applying substantially uniform pressure on electrode stacks or arrays. In one example approach, a battery cell constraint system is provided herein that comprises a battery cell stack; a first endplate positioned over a first face of the stack; a second endplate positioned over a second face of the stack, where the first face opposes the second face; a first chamber filled with hydraulic fluid between the first endplate and a first flexible membrane above the first face of the stack; and a second chamber filled with hydraulic fluid between the second endplate and a second flexible membrane above the second face of the stack. In some examples, the battery cell constraint systems provided herein may further comprise an annular frame that surrounds the battery cell stack.

In such an approach, thin chambers filled with pressurized fluid may be positioned on opposing faces of an electrode stack. Compression forces may then be transmitted to the stack through a flexible membrane separating the thin chamber and the stack. In some examples, a gap between the stack and a containment frame (i.e., an annular frame) may be minimized and/or filled with polymer. Such an approach may provide substantially uniform pressure across the faces of the cell stack and may increase support along peripheral edges of the cells thereby potentially increasing efficiency of battery cell operation.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example electric vehicle with a battery.

FIG. 2 shows an illustration of an example bipolar battery cell.

FIG. 3 shows an illustration of an example monopolar battery cell.

FIG. 4 shows an example cell constraint fixture.

FIG. 5 shows an example hydrostatically constrained electrode stack.

FIG. 6 shows an example constraint fixture with multiple hydrostatically constrained electrode stacks.

FIG. 7 shows an example of multiple electrode stacks arrayed vertically in a single constraint fixture.

FIG. 8 shows an example of multiple electrode stacks arrayed horizontally with multiple pressurized chambers in a constraint fixture.

### DETAILED DESCRIPTION

The following description relates to hydrostatic constraint systems for applying substantially uniform pressure on electrode stacks or arrays in battery cell stacks, e.g., in solid-state battery applications. As remarked above, solid state battery cells, e.g., solid-state lithium-ion battery cells, may use constraint systems to apply forces normal or uniaxial (i.e., in a direction along one axis, such as the z-axis) to the electrode stacking planes (i.e., the stacking planes may be in a plane perpendicular to the axis along which the forces are applied, e.g., the x-y plane). Such constraint systems may be used to ensure close contact between electrodes and separators during use to maintain power and cycle life capability of the battery. Solid-state batteries may use very high forces to ensure close contact between the electrodes in a stack. Constraint plate systems may be used to package a subset or array of battery cells to form a battery pack, in some examples. In some examples, such constraint plate systems may comprise opposing rigid plates that sandwich a stack of cells. The constraint forces may be applied by bolts or other adjustable components distributed around the periphery of the constraint plates. In such approaches, external bolts may form a moment arm about the edge of the cell stack, resulting in bending of the plates and an uneven distribution of pressure across the cell stack. The application of an uneven pressure across a cell stack may result in uneven contributions of different regions of the cells and uneven degradation of different cell areas, which may lead to inefficiencies in battery cell operation.

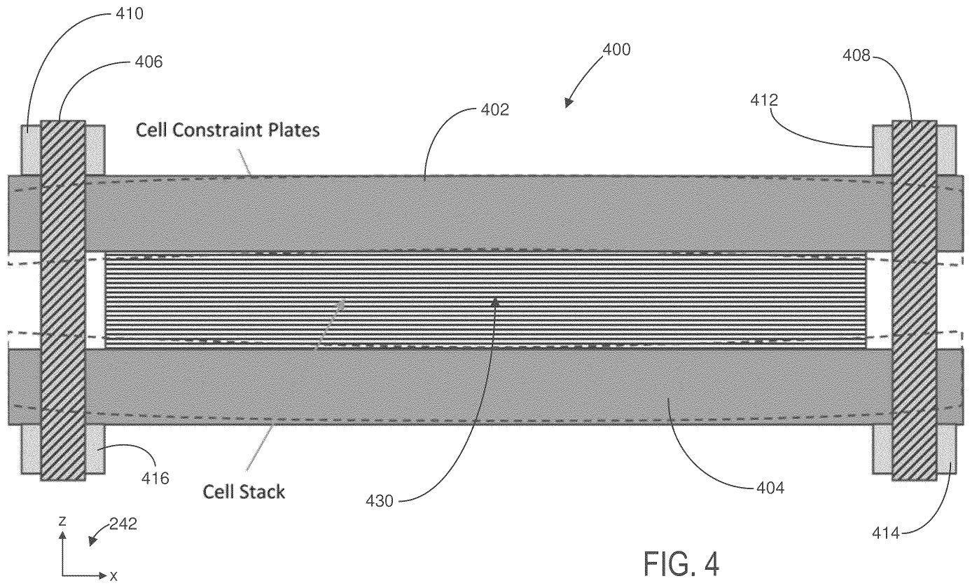

For example, solid-state batteries may use as much as ten times the force used for liquid electrolyte lithium ion battery cells. Conventional constraint plate systems may be used to package a subset or array of battery cells to form a battery pack, in some examples. For example, as illustrated in FIG. 4, such constraint plate systems (e.g., constraint system 400) may comprise opposing rigid plates 402 and 404 that sandwich a stack of cells 430. The constraint forces may be applied by bolts, e.g., bolts 406 and 408 shown in FIG. 4, or other adjustable components distributed around the periphery or edges of the constraint plates. For example, in FIG. 4, bolts 406 and 408 extend through the top plate 402 and the bottom plate 404 and compress the plates around the electrode stack by tightening nuts 410 and 416 on bolt 406 and nuts 412 and 414 on bolt 408. Such bolts or other tightening mechanisms may be arrayed around a periphery (e.g., just beyond the edge or outer perimeter) of the cell stack.

In such constraint approaches, where bolts or other mechanisms compress rigid plates around the periphery of an electrode stack, the external bolts or tightening mechanisms around the perimeter of the stack may form a moment arm about the edge of the cell stack, resulting in bending of the plates and an uneven distribution of pressure across the cell stack. For example, in FIG. 4 shows dashed lines that illustrate the bending of the plates as the compression is increased (e.g., as the nuts 410, 416, 412, and 414 are tightened on bolts 406 and 408). This bending of the plates may lead to uneven pressure on the cell stack. As remarked above, the application of an uneven pressure across a cell stack may result in uneven contributions of different regions of the cells and uneven degradation of different cell areas, which may lead to inefficiencies in battery cell operation.

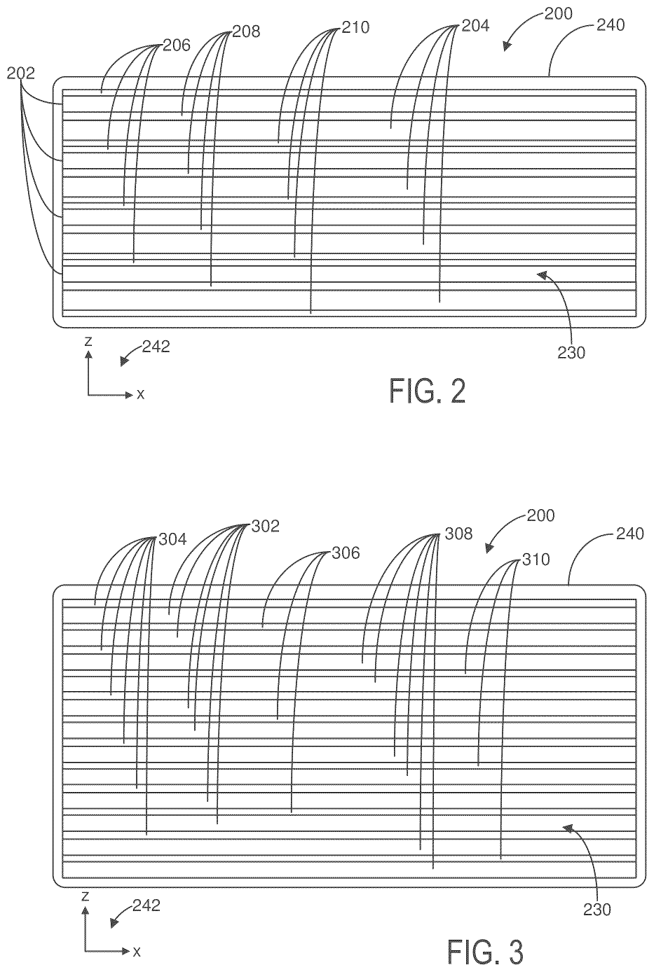

In some approaches, the uneven pressure may be counteracted by making the end-plates thicker and/or the cell dimensions smaller. However, such an approach may be in opposition to desirable design targets for batteries to have less weight, be less bulky and use less expensive packaging methods. As electrodes get larger (e.g., larger in the x-y plane of the electrode) the effects of non-uniform pressure may become more significant and may reduce achievable dimensions of cells. For example, for bipolar cells (an example of which is shown in FIG. 2 described below), the reduction of achievable dimensions of the cell may reduce achievable energy density that can be realized in a pouch configuration.

Constraint systems and constraint mechanisms are provided herein to provide uniform pressure over target pressure thresholds (e.g., to provide uniform pressure greater than or substantially equal to 1 MegaPascal, MPa) on stack of electrodes using hydrostatic electrode stack or array constraint devices. In such devices, thin chambers filled with pressurized fluid may be positioned on opposing faces of an electrode or cell stack. Compression force may be transmitted to the stack through a flexible membrane separating the thin chamber and stack. To reduce large unsupported portions of the membrane at the periphery of the stack, the gap between the stack and a containment frame (i.e., an annular frame) may be minimized and/or filled with polymer. In some examples, the pressurization to the fluid chambers may be permanently fixed at the time of assembly, or may be adjustable during operation or over the life of the vehicle, for example. The chamber may be connected with pressure contoller, fluid reservoir and/or pump to allow active chamber pressure monitoring and control in some examples. The fluid may be any suitable incompressible fluid, such as a conventional hydraulic fluid, or other fluid that does not freeze in the temperature range of operation of the vehicle, including a compressed gas, or a mixture of fluids and solids such as spherical beads. For example, the flexible membrane may be metal sheet, a rubber or polymer sheet or a composite of several materials.

The cell stack may comprise monopolar cells (e.g., as shown in FIG. 3 described below) or bipolar cells (e.g., as shown in FIG. 2 described below). For a bipolar cell, the membrane may further serve as a current collection tab on a cell stack provided that the two membranes are electrically isolated from one another. In some examples, the annular space surrounding the cell stack may be vented to ambient pressure. In other examples, this annular portion may be filled with another fluid or solid polymer to provide additional support to the edges of the cell and may also affect heat conduction. In some examples, the flexible membrane may be further electrically isolated from the end portions of the pressure chambers. In some examples, the end plates may contain fluid passages to enable heat removal.

It is to be understood that the specific assemblies and systems illustrated in the attached drawings, and described in the specification are example embodiments of the inventive concepts defined herein. For purposes of discussion, the drawings may be described collectively. Thus, like elements may be commonly referred to herein with like reference numerals and may not be re-introduced.

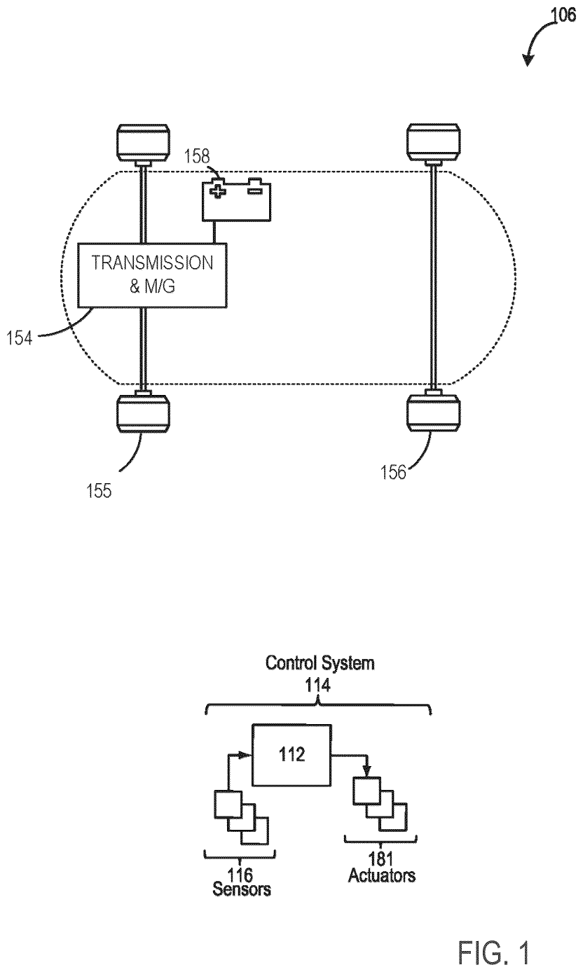

Turning now to the figures, FIG. 1 shows a schematic depiction of an example vehicle system 106 that can derive propulsion power from an electric motor 154 (e.g., a drive motor). As used herein, the terms “electric vehicle” or “EV” is intended to mean any suitable vehicle that is at least partially configured to be propelled using electric power, e.g., via one or more electric motors incorporated in the vehicle. For example, vehicle system 106 may be considered to be an electric vehicle (EV). Though FIG. 1 shows a single electric motor 154, it should be understood that vehicle system 106 may include any suitable number of electric motors to propel the vehicle and/or provide power to various components and systems within system 106. In some examples, electric motor 154 may be a traction motor, however other types of electric motors are contemplated. Electric motor 154 may receive electrical power from a battery 158 to provide torque to vehicle wheels 155. Electric motor 154 may also be operated as a generator to provide electrical power to charge battery 158, for example, during regeneration operation. In some examples, battery 158 may comprise a solid-state battery (SSB).

It should be appreciated that while FIG. 1 depicts an electric motor 154 mounted in a rear wheel drive configuration, other configurations are possible, such as employing electric motor 154 in a front wheel configuration, or in a configuration in which there is an electric motor mounted to both the rear vehicle wheels 155 and front vehicle wheels 156. Further, additional electric motors may be included in system 106.

Electric motor 154 may include a gearbox integrated therein and/or may provide input power, together with other electric motors, to a transmission system. Additionally, or alternatively, the electric motor 154 may be coupled to an outside of a transmission/gearbox housing. The integrated gearbox may include one or more input speed reduction gear sets. Electric motor 154 may also include at least one clutch. Controller 112 may send a signal to an actuator of the clutch(es) to engage or disengage the clutch(es), so as to couple or decouple power transmission from the electric motor 154 to the rear vehicle wheels 155 or the front vehicle wheels 156. Additionally, or alternatively, there may be multiple batteries configured to provide power to different driven wheels, wherein power to the wheels may be predicated based on traction at the wheels, driver demand, and other conditions.

Controller 112 may form a portion of a control system 114. Control system 114 is shown receiving information from a plurality of sensors 116 and sending control signals to a plurality of actuators 181. As one example, sensors 116 may include sensors such as a battery level sensor, clutch activation sensor, etc. As another example, the actuators may include the clutch, etc. The controller 112 may receive input data from the various sensors, process the input data, and trigger the actuators in response to the processed input data based on instructions or code programmed therein corresponding to one or more routines.

Turning now to FIGS. 2-8, various views of an example battery cell stacks 200 and battery cell constraint systems 400 are shown. An axis system 242 is provided in the FIGS. 2-8 for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples.

FIG. 2 shows a cross-sectional view of example battery 200 with an electrode stack 230 enclosed in a pouch 240. The example solid-state battery shown in FIG. 2 has a bipolar cell structure (an example battery with monopolar cell structure is shown in FIG. 3, where like elements use like numbering). Pouch 240 may form a container, a pocket or a cavity which houses the electrode assembly including the electrode stack 230. In some embodiments, the pouch 240 may comprise a porous plastic tube, pouch, or sleeve made of any suitable material. Stack 230 comprises a plurality of electrodes and other components of a solid-state battery, such as electrode coatings, current collectors, solid-state electrolytes separators, etc. For example, as shown in FIG. 2, electrode stack 230 comprises a plurality of anodes 202 (i.e., negatively charged electrodes) and a plurality of cathodes 204 (i.e., positively charged electrodes) arranged in a stack formation. Each anode may have an anode current collector 206 (i.e., an anode electrical contact) that is in contact with a surface of the anode. Each cathode may have a cathode current collector 210 (i.e., a cathode electrical contact) that is in contact with a surface of the cathode. The anodes and cathodes included in stack 230 may have various coatings disposed thereon in some examples. Solid-state electrolytes 208 (i.e., solid-state separators) may be disposed between the anodes and cathodes.

As remarked above, battery 200 may comprise a solid-state battery. A solid-state battery is an electrical battery that uses a solid electrolyte for ionic conductions between the electrodes, instead of liquid or gel polymer electrolytes found in conventional batteries. Solid-state batteries may provide higher energy density than the typical lithium-ion or lithium polymer batteries. The cathodes 204 (i.e., positive electrodes) may be made with the same compounds as a lithium-ion battery (e.g., LFP, NMC, LMO, etc). The anodes 202 (i.e., negative electrodes) may be made of lithium metal (e.g., pure lithium) in some examples. In some examples, a negative electrode may be formed by coating a negative electrode active material such as a lithium metal, a lithium alloy, carbon, petroleum coke, activate carbon, graphite, silicon, silicon oxide, silicon composite, titanium-based material, or the like, on both surfaces of a negative electrode current collector made of copper, nickel, a copper alloy, other potential conductive materials, or any combination thereof. Also, a positive electrode may be formed by coating a positive electrode active material such as a lithium manganese oxide, a lithium cobalt oxide, a lithium nickel oxide, or the like, on both surfaces of a positive electrode current collector made of aluminum, nickel, other potential conductive materials, or a combination thereof.

As illustrated in FIG. 2, the negative electrodes 202 and the positive electrodes 204 may be stacked with separators 208. The separators 208 may be comprised of a ceramic material (e.g., oxides, sulfides, phosphates), or a solid polymer, which also functions as the electrolyte. It therefore becomes the medium through which the ions move and also has electric insulating properties and functions as a mechanical separator between the anodes and cathodes. The solid electrolyte may function as an ideal separator that allows only lithium ions to pass through. For that reason, solid-state batteries can potentially address issues related to currently used liquid electrolyte Li-ion batteries, such as flammability, limited voltage, solid-electrolyte interface formation stability, cycling performance, and strength. The separators may be made of a material generally used in the art. For example, a multi-layer film made of polyethylene, polypropylene, or a combination thereof having a microporous structure, or a polymer film for a gel-type polymer electrolyte or a solid polymer electrolyte such as polyvinylidene fluoride, polyethylene oxide, polyacrylonitrile, or polyvinylidene fluoride hexafluoropropylene copolymer may be used.

FIG. 3 shows a cross-sectional view of an example solid-state battery 200 with a monopolar cell structure. Like-numbered elements shown in FIG. 3 correspond to like-numbered elements shown in FIG. 2 described above. The example monopolar electrode stack 230 shown in FIG. 3 comprises an anode layer that comprises solid electrolyte separators 304 that form boundaries to anode coatings 302 on top and bottom surfaces of anode current collectors 306. The cathode layers in this example comprise cathode coatings 308 on top and bottom surfaces of cathode current collectors 310.

The electrodes and other components in the electrode stacks 230 shown in FIGS. 2 & 3 may be laminated together to affix all the components together. Lamination is a technique/process of manufacturing a material in multiple layers. A laminate is a layered object or material that may be assembled using heat, pressure, welding, or adhesives. Various coating machines, machine presses and/or calendering equipment may be used to laminate the layers in the electrode stacks 230.

As remarked above, solid state battery cells, e.g., solid-state lithium-ion battery cells, may use constraint systems to apply forces normal or uniaxial (i.e., in a direction along one axis, such as the z-axis) to the electrode stacking planes (i.e., the stacking planes may be in a plane perpendicular to the axis along which the forces are applied, e.g., the x-y plane). Such constraint systems may be used to ensure close contact between electrodes and separators during use to maintain power and cycle life capability of the battery. Solid-state batteries may use very high forces to ensure close contact between the electrodes in a stack and to overcome electrode degradation during cycling. For example, for solid-state batteries with a lithium (Li) metal anode, compression may be used to overcome formation of porous Li deposits during charging and to overcome mechanical degradation of interfaces between solid layers. In some examples, liquid electrolyte Li ion cells may use up to 2 MPa of constraint pressure, and solid-state batteries that are based on sulfide solid electrolytes may use up to ten times that pressure. In some approaches, a fixturing system may be used to compress a cell or stack of cells using parallel plates bolted together, e.g., as illustrated in FIG. 4.

As illustrated in FIG. 4 and described above, such constraint plate systems (e.g., constraint system 400) may comprise opposing rigid plates 402 and 404 that sandwich a stack of cells 430. The rigid plates 402 and 404 may be substantially parallel to each other, i.e., they may lie in substantially the same plane (the x-y plane in FIG. 4) and be positioned above and below (along the z-axis) a stack of electrodes 430. These rigid plates may be configured to be tightened onto the electrode stack 430 to apply a target compression force to the electrode stack 430. For example, the constraint forces may be applied by bolts, e.g., bolts 406 and 408 shown in FIG. 4, or other adjustable components distributed around the periphery or edges of the constraint plates 402 and 404. For example, in FIG. 4, bolts 406 and 408 extend through the top plate 402 and the bottom plate 404 and compress the plates around the electrode stack by tightening nuts 410 and 416 on bolt 406 and nuts 412 and 414 on bolt 408. Such bolts or other tightening mechanisms may be positioned around a periphery (e.g., just beyond the edge or outer perimeter) of the cell stack 430.

As remarked above, in such constraint approaches where bolts or other mechanisms compress rigid plates around the periphery of an electrode stack (e.g., such as illustrated in FIG. 4), the external bolts or tightening mechanisms around the perimeter of the stack may form a moment arm about the edge of the cell stack, resulting in bending of the plates and a non-uniform pressure distribution across the faces of the cell or cell stack due to bending of the plates. For example, FIG. 4 shows dashed lines that illustrate the bending of the plates as the compression is increased (e.g., as the nuts 410, 416, 412, and 414 are tightened on bolts 406 and 408). This bending of the plates may lead to uneven pressure on the cell stack resulting in uneven contributions of different regions of the cells and uneven degradation of different cell areas, which may lead to inefficiencies in battery cell operation.

As remarked above, in some approaches the uneven pressure may be counteracted by making the end-plates (e.g., plates 402 and 404) thicker and/or the cell dimensions smaller, but this may be in opposition to desirable design targets for batteries to have less weight, be less bulky and use less expensive packaging methods. In order to achieve more uniform pressure around electrode stacks, hydrostatic approaches may be used, as described herein, where chambers filled with a suitable hydraulic fluid are positioned above and below an electrode stack to equalize compression forces when rigid plates are tightened around the electrode stack. Such hydrostatic approaches may be used to apply substantially uniform pressure regardless of the thickness or uniformity of the cell or electrode stack. However, completely immersing a cell in a hydrostatic fluid may have the effect that pressure is applied along the edges of electrodes in cells, which may result in degradation of battery operation. For example, to reduce Li plating during charging, cells may be built with overhanging anode electrodes and pressure applied along the edges of cells can push these overhanging anode edges into adjacent cathodes, leading to short circuits. Thus, it may be desirable to use a constraint mechanism that applies substantially uniform pressure on the faces of the electrode stack (for a pouch cell) and little or no pressure applied on the edges of the electrode stack.

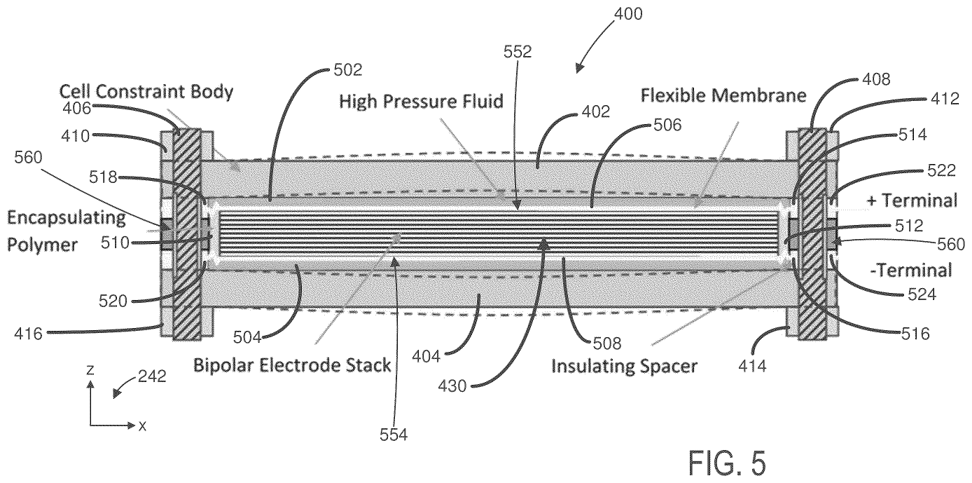

FIG. 5 shows a cross-sectional view of a hydrostatically constrained electrode stack 430, where distortion of the constraint structure 400 (i.e., distortion of top and bottom plates 402 and 404) due to tightening of tightening mechanisms 406 and 408 along the periphery is shown in dashed lines. The battery cell constraint system 400 shown in FIG. 5 comprises a battery cell stack 430. The battery cell stack may be any suitable solid-state battery cell stack. For example, battery cell stack 430 may comprise a bipolar battery cell stack (e.g., as illustrated in FIG. 2 described above). As another example, battery cell stack 430 may comprise a monopolar battery cell stack (e.g., as illustrated in FIG. 3 described above).

The constraint system 400 comprises a first endplate 402 positioned over a first face 552 of the stack 430 and a second endplate 404 positioned over a second face 554 of the stack 430. For example, the first endplate 402 may comprise a rigid metal plate positioned over one surface of the electrode stack (e.g., a top surface) and the second endplate 404 may comprise a rigid metal plate positioned over the opposite surface of the electrode stack (e.g., bottom surface). In this endplate configuration, the two endplates are located on opposites sides or opposing faces of the electrode stack. The rigid plates thereby sandwich the electrode stack between the two plates so that when the plates are tightened together, they exert a compression force on the electrode stack. The first and second endplates 402 and 404 may be mechanically constrained to move in a normal direction (e.g., in z-axis direction in axes 242) to the first and second faces 552 and 554 of the stack 430.

The constraint system 400 further comprises a first chamber 502 filled with hydraulic fluid between the first endplate 402 and a first flexible membrane 506 above the first face 552 of the stack 430. Additionally, constraint system 400 comprises a second chamber 504 filled with hydraulic fluid between the second endplate 404 and a second flexible membrane 508 above the second face 554 of the stack 430. In some examples, the chambers may be formed as cavities between an electrode stack-facing surface of the rigid plate and the flexible membrane located on the face of the electrode stack. The flexible membranes may be made of any suitable material, a material that provides some amount of flexibility. For example, the flexible membrane may be metal sheet, a rubber or elastic polymer sheet or a composite of several materials. The fluid chambers 502 and 504 may be substantially sealed off from the environment and filled with hydraulic fluid. In some embodiments, the fluid chambers may be a separate hollow bodies filled with fluid and interposed between the end plates and the electrode stack, such as sealed bellows. By providing fluid chambers on both sides of the electrode stack, the stack may be supported by the membranes and without rigid attachment points.

The constraint system 400 may further comprise a plurality of fasteners positioned on the plates along an outside edge or periphery of electrode stack 430. For example, FIG. 5 shows example fasteners 406 and 408 that are positioned just beyond or adjacent to the edges of the electrode stack 430 on the two opposing plates and may be used to tighten the plates around the electrode stack. For example, as illustrated in FIG. 5, constraint forces may be applied by bolts, e.g., bolts 406 and 408 distributed around the battery cell stack and configured to tighten the first and second endplates around the battery cell stack. In this example, illustrated in FIG. 5, bolts 406 and 408 extend through the top plate 402 and the bottom plate 404 and compress the plates around the electrode stack by tightening nuts 410 and 416 on bolt 406 and nuts 412 and 414 on bolt 408. Such bolts or other tightening mechanisms may be arrayed around a periphery (e.g., just beyond the edge or outer perimeter) of the cell stack.

The flexible membranes (e.g., flexible membranes 506 and 508) may be used to transmits hydrostatic pressure from the hydraulic-fluid-filled first and second chambers 502 and 502 onto the surface (e.g., onto faces 552 and 554) of the electrode stack 430. The membranes (e.g., membranes 506 and 508) may be deformable, so that they conform to any large-scale non-uniformities in the thickness of the stack. In such devices, these thin chambers (e.g. chamber 502 and 504) filled with pressurized fluid may be positioned on opposing faces (faces 552 and 554) of an electrode or cell stack. Compression forces may be transmitted to the stack 430 through flexible membranes (e.g., membranes 506 and 508) separating the thin chamber and stack. In this approach, the internal pressure may be substantially uniformly distributed over the faces of the cell stack because of the lack of pressure gradients in the fluid in the chambers.

In some example, a containment frame or annular frame 560 may be included in constraint system 400. The annular frame 560 may surround the battery cell stack or extend completely around the outer perimeter or outer edges of electrode stack 430. Such a frame may be used to reduce deformation of the membrane from damaging the edges of the stack, since the stack is positioned inside the frame. In some examples, there may be minimal clearance between the stack and the frame such that the membrane is only unsupported over a short distance. For example, a distance between the outer edges of the cell stack and the inner surface of the frame may be less than a threshold amount, e.g., may be less than 10 mm, or less than 5 mm, or less than 1 mm. To reduce large unsupported portions of the membrane at the periphery of the stack, the gap between the stack and the containment frame (i.e., the annular frame) may be minimized and/or filled with polymer, e.g., the gap may be filled with an encapsulating polymer 510. The encapsulating polymer may comprise any suitable polymer configured to fill the gap or space between an inner surface of the frame and the outer edge of the cell stack. For example, the encapsulating polymer may comprise a polymer solid, such as an epoxy, or a room temperature vulcanized elastic material, or the like.

In some examples, the membranes (e.g., membranes 506 and 508) may further incorporate a support structure integrated into or located around the perimeter of each of the first and second flexible membranes. For example, the support structure may comprise a “wave” feature around the perimeter of the stack to enhance the local rigidity of the membrane in the unsupported region. However, it should be understood than any suitable support structure is contemplated, including but not limited to: a thicker polymer region around the outside edges of the chambers or an integrated support piece such as a metal, polymer, or plastic structure that is included in the edges of the chamber to provide support. These support features may have any suitable shape to increase support along the edges of the chamber. For example, the support features may be wave-shaped, sinusoidal-shaped, zig-zag-shaped, square-wave-shaped, etc.

As in the case of the conventional plate-type constraint fixture (such a s shown in FIG. 4), the cover plates (e.g., plates 402 and 404) defining the upper and lower fluid chambers may bend when the internal pressure of the fluid is increased. However, unlike the conventional fixture, a fluid cannot support a pressure gradient, so the pressure applied to the membrane may be substantially uniform and hence, the pressure applied to the faces of the electrode stack may be substantially uniform regardless of the bending of the plates. By providing fluid chambers on both sides of the electrode stack, the stack may be supported by the membranes and without rigid attachment points.

In some examples, the pressurization to the fluid chambers (e.g., chambers 504 and 502) may be permanently fixed at the time of assembly, or may be adjustable during operation or over the life of the vehicle, for example. The chambers may be connected with a pressure controller, fluid reservoir and/or pump to allow active chamber pressure monitoring and control in some examples. The fluid may be any suitable incompressible fluid, such as a conventional hydraulic fluid, or other fluid that does not freeze in the temperature range of operation of the vehicle, including a compressed gas, or a mixture of fluids and solids such as spherical beads. For example, the hydraulic fluid may be a gas at ambient pressure, or may comprise a semi-solid material. In some examples, the hydraulic fluid may form a low-viscosity fluid before being introduced into the first and second chambers and form a high viscosity fluid or semi-solid material after being introduced into the first and second chambers.

The cell stack may comprise monopolar cells (e.g., as shown in FIG. 3 described above) or bipolar cells (e.g., as shown in FIG. 2 described above). For a bipolar cell, the membranes may further serve as a current collection tab on a cell stack provided that the two membranes are electrically isolated from one another. In some examples, the annular space surrounding the cell stack may be vented to ambient pressure. In other examples, this annular portion may be filled with another fluid or solid polymer to provide additional support to the edges of the cell and may also improve heat conduction. In some examples, the flexible membrane may be further electrically isolated from the end portions of the pressure chambers. In some examples, the end plates may contain fluid passages to enable heat removal.

For a bipolar electrode stack, the only electrical connections to the cell are through current collectors at the faces of the stack. Thus, in some examples the first and second flexible membranes 506 and 508 may be electrically conductive and may form external terminals of the battery cell stack. For example, the membranes 502 and 504 may be a conductive material (e.g., a conductive metal) and the membranes may form the external terminals of the battery. For example, as shown in FIG. 5, membranes 502 and 504 form terminals 522 and 524 for the cell provided that the membranes are electrically isolated from the constraint hardware. Additionally, the annular frame 560 may include electrical isolator feed-throughs and/or insulating spacers (e.g., feed troughs or spacers 514 and 516 shown in FIG. 5). In some examples, there may be restriction on the height of the fluid chambers provided that the membrane is fully supported by the fluid pressure it contains. Thus, in some examples, the chamber may be very shallow and its thickness may be based on a self-diffusion length of the fluid inside the chamber. The fluid chosen to fill the chambers may be any liquid or gas that cannot freeze in the temperature range of operation or storage. In some cases, the fluid may comprise a semi-solid material such as a viscous grease. In some embodiments, the pressure medium or fluid may be selected based on it having a high thermal conductivity or thermal heat capacity. In some embodiments, a fluid may be chosen based on it functioning as fire-suppressant. In some embodiments, the pressure medium may be introduced while in a low viscosity form, which subsequently undergoes partial polymerization to form a semi-solid pressure medium in the chambers.

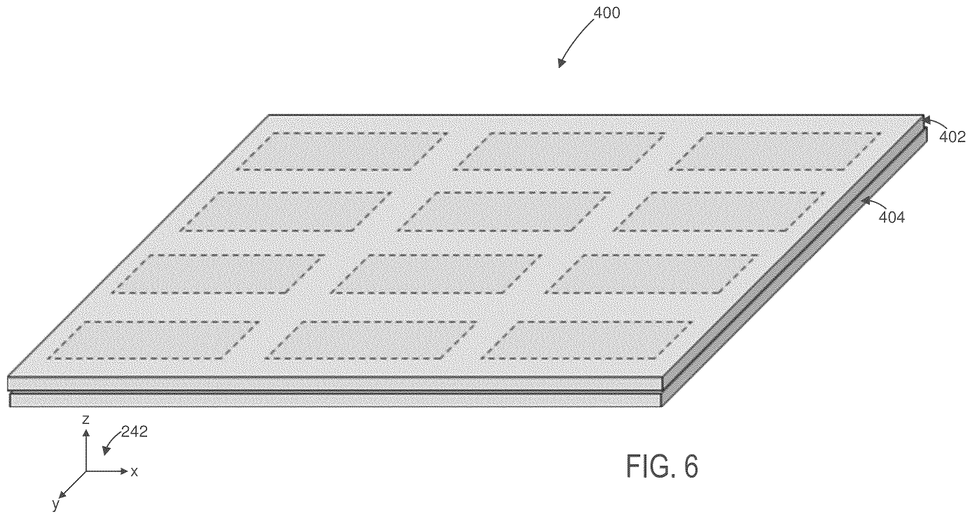

FIG. 6 shows an example constraint fixture with multiple hydrostatically constrained electrode stacks (located in the areas shown by dashed lines). In this example, a plurality of battery cell stacks may be arranged in a horizontal plane (e.g., the x-y plane as shown in FIG. 6). The first endplate 402 may be positioned over first faces of each stack in the plurality of battery cell stacks. A second endplate 404 is positioned over second faces of each stack in the plurality of battery cell stacks, where the first faces oppose the second faces. Each battery cell stack in this example is configured similar to that shown in FIG. 5 described above. In particular, each electrode stack has a first chamber filled with hydraulic fluid between the first endplate 402 and a first flexible membrane above the first face of the stack and a second chamber filled with hydraulic fluid between the second endplate 404 and a second flexible membrane above the second opposing face of the stack. In this example, a single top plate (402) and a single bottom plate (404) compress chambers positioned over the top and bottom faces of multiple stacks to apply a substantially uniform compression to each stack in the plurality of stacks. Additionally, in some examples, annular frames may be included that surround each battery cell stack in the plurality of battery cell stacks.

In the example illustrated in FIG. 6, the chambers defined by the endplates and membranes may be extended to enclose more than one electrode or cell stack. To reduce excessive deformation of the endplates, spaces between electrode stack may include additional through-bolts or other suitable tightening mechanisms. In this way, the structure may be extended to enclose many electrode stacks in a single rigid body. This rigid body may enhance the mechanical strength of a vehicle body and form an integral part of the vehicle chassis, in some examples.

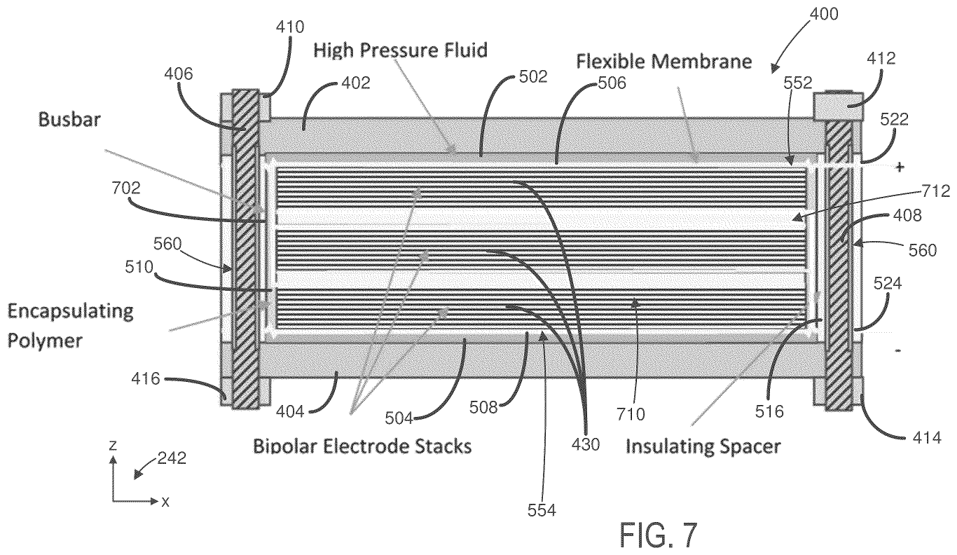

FIG. 7 shows an example of multiple electrode stacks arrayed vertically (e.g., arranged in the z-axis direction) in a single constraint fixture 400. In this example, the battery cell constraint system 400 comprises a plurality of battery cell stacks 430 arranged in a vertical stack 710. In particular, two or more battery cell stacks are stacked on top of each other in this example (the example illustrated in FIG. 7 shows three different battery cell stacks arranged together vertically). In this example, the battery cell stacks 430 in the vertical stack 710 may be separated from each other by an insulating material 712. The insulating material may comprise any suitable material that is non-conductive or that ionically and electronically isolates each of the different electrode stacks from each other.

As in the previous examples, an annular frame 560 may be included that surrounds the vertical stack 710. A first endplate 402 may be positioned over a first face 552 of the vertical stack 710 and a second endplate 404 may be positioned over a second face 554 of the vertical stack 710, where the first face 552 opposes the second face 554 (i.e., the first face 552 is on an opposite side of the vertical stack 710 from the second face 554). In this example, a first chamber 502 filled with hydraulic fluid is formed between the first endplate 402 and a first flexible membrane 506 above the first face of the vertical stack 710; and a second chamber 504 filled with hydraulic fluid is formed between the second endplate 404 and a second flexible membrane 508 above the second face 554 of the vertical stack 710. Thus, in this example, the first and second chambers are positioned around multiple different stacks so that when compressed by the endplates, they apply a substantially uniform compression force to the different electrode stacks included in the vertical stack. In this example, the battery cell stacks 430 in the vertical stack 710 may be connected electrically in parallel.

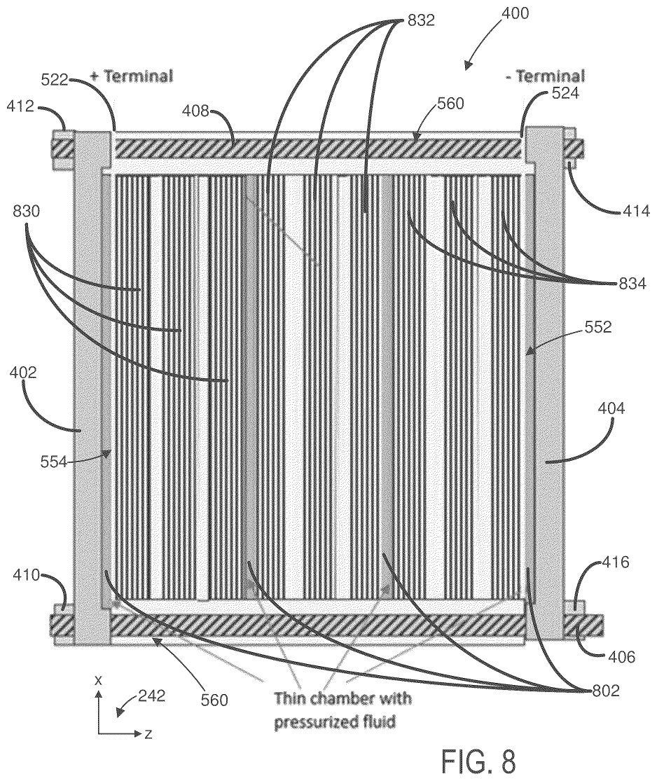

FIG. 8 shows an example of multiple electrode stacks 430 arrayed horizontally with multiple pressurized chambers 802 between the different electrode stacks arranged in a constraint fixture 400. Similar to FIG. 7 described above, multiple electrode stacks are arranged together in a single constraint fixture; but, in this example, each electrode stack in the horizontal arrangement of stacks is separated from the other via a hydraulic chamber. In this approach, non-uniformities in the pressure transmitted between stacks through the rigid insulator plates (402 and 404) may be further reduced due to the additional chambers included between the electrode stacks. In this examples, the different electrode stacks may be connected in parallel or in series or in any suitable electronic arrangement depending on the application of the battery.

FIGS. 1-8 are drawn approximately to scale, aside from the schematically depicted components. However, the components may have other relative dimensions, in other embodiments. The figures show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Even further, elements which are coaxial or parallel to one another may be referred to as such.

The invention will be further described in the following paragraphs. In one aspect, a battery cell constraint system is provided that comprises a battery cell stack; a first endplate positioned over a first face of the stack; a second endplate positioned over a second face of the stack, where the first face opposes the second face; a first chamber filled with hydraulic fluid between the first endplate and a first flexible membrane above the first face of the stack; and a second chamber filled with hydraulic fluid between the second endplate and a second flexible membrane above the second face of the stack. In some examples, the battery cell constraint system may further comprise an annular frame that surrounds the battery cell stack.

In some aspects, the first and second endplates of the battery cell constraint system may be mechanically constrained to move in a normal direction to the first and second faces of the stack. In additional aspects, the battery cell constraint system may further comprise a plurality of fasteners distributed around the battery cell stack that are configured to tighten the first and second endplates around the battery cell stack. In some examples, the battery cell stack may comprise a solid-state battery cell stack. The battery cell stack may comprise a monopolar solid-state battery cell stack; or the battery cell stack may comprise a bipolar solid-state battery cell stack. In some aspects, the first and second flexible membranes in the battery cell constraint system may be electrically conductive. In some examples, the first and second flexible membranes of the battery cell constraint system may be electrically conductive and form external terminals of the battery cell stack. In some aspects, the battery cell constraint system may further comprise an encapsulating material between the battery cell stack and the annular frame. For example, the encapsulating material may comprise a polymer. In some examples, the hydraulic fluid in the battery cell constraint system may be a gas at ambient pressure. In other examples, the hydraulic fluid in the battery cell constraint system may comprise a semi-solid material. In still other examples, the hydraulic fluid in the battery cell constraint system may comprise a low-viscosity fluid before introduced into the first and second chambers and may form a high viscosity fluid or semi-solid material after being introduced into the first and second chambers in the battery cell constraint system.

In some aspects, the first and second flexible membranes in the battery cell constraint system may comprise an elastic polymer. In some examples, the annular frame in the battery cell constraint system may include electrical isolator feed-throughs. In additional aspects, the first and second flexible membranes in the battery cell constraint system may comprise a support structure, e.g., a wave feature or the like, around the perimeter of each of the first and second flexible membranes.

In additional aspects, a battery cell constraint system is provided that comprises a plurality of battery cell stacks arranged in a horizontal plane; a plate with annular frames that surround each battery cell stack in the plurality of battery cell stacks; a first endplate positioned over first faces of each stack in the plurality of battery cell stacks; a second endplate positioned over second faces of each stack in the plurality of battery cell stacks, where the first faces oppose the second faces; first chambers filled with hydraulic fluid between the first endplate and first flexible membranes above the first face of each stack in the plurality of battery cell stacks; and second chambers filled with hydraulic fluid between the second endplate and second flexible membranes above the second face of each stack in the plurality of battery cell stacks. In some examples, the first and second flexible membranes in the battery cell constraint system may be electrically conductive. In some examples, the battery cell constraint system may further comprise an encapsulating material between each battery cell stack and the annular frame surrounding that battery cell stack, wherein the encapsulating material is ionically and electronically insulating.

In additional aspects, a battery cell constraint system is provided that comprises a plurality of battery cell stacks arranged in a vertical stack; an annular frame that surrounds the vertical stack; a first endplate positioned over a first face of the vertical stack; a second endplate positioned over a second face of the vertical stack, the first face opposing the second face; a first chamber filled with hydraulic fluid between the first endplate and a first flexible membrane above the first face of the vertical stack; and a second chamber filled with hydraulic fluid between the second endplate and a second flexible membrane above the second face of the vertical stack. In some examples, the battery cell stacks in the vertical stack may be separated from each other by an insulating material. In some examples, the battery cell stacks in the vertical stack may be connected electrically in parallel.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery cell constraint system, comprising:
a battery cell stack;
a first endplate positioned over a first face of the stack;
a second endplate positioned over a second face of the stack, the first face opposing the second face;
a first chamber filled with hydraulic fluid between the first endplate and a first flexible membrane above the first face of the stack; and
a second chamber filled with hydraulic fluid between the second endplate and a second flexible membrane above the second face of the stack.

2. The system of claim 1, further comprising an annular frame that surrounds the battery cell stack.

3. The system of claim 1, further comprising a plurality of fasteners distributed around the battery cell stack and configured to tighten the first and second endplates around the battery cell stack.

4. The system of claim 1, wherein the battery cell stack comprises a monopolar solid-state battery cell stack.

5. The system of claim 1, wherein the battery cell stack comprises a bipolar solid-state battery cell stack.

6. The system of claim 1, wherein the first and second flexible membranes are electrically conductive.

7. The system of claim 1, wherein the first and second flexible membranes are electrically conductive and form external terminals of the battery cell stack.

8. The system of claim 2, further comprising an encapsulating material between the battery cell stack and the annular frame.

9. The system of claim 8, wherein the encapsulating material comprises a polymer.

10. The system of claim 1, wherein the hydraulic fluid is a gas at ambient pressure.

11. The system of claim 1, wherein the hydraulic fluid comprises a semi-solid material.

12. The system of claim 1, wherein the first and second flexible membranes comprise an elastic polymer.

13. The system of claim 2, wherein the annular frame includes electrical isolator feed-throughs.

14. The system of claim 1, wherein the first and second flexible membranes comprise a support structure around the perimeter of each of the first and second flexible membranes.

15. A battery cell constraint system, comprising:
a plurality of battery cell stacks arranged in a horizontal plane;
a plate with annular frames that surround each battery cell stack in the plurality of battery cell stacks;
a first endplate positioned over first faces of each stack in the plurality of battery cell stacks;
a second endplate positioned over second faces of each stack in the plurality of battery cell stacks, where the first faces oppose the second faces;
first chambers filled with hydraulic fluid between the first endplate and first flexible membranes above the first face of each stack in the plurality of battery cell stacks; and
second chambers filled with hydraulic fluid between the second endplate and second flexible membranes above the second face of each stack in the plurality of battery cell stacks.

16. The system of claim 15, wherein the first and second flexible membranes are electrically conductive.

17. The system of claim 15, further comprising an encapsulating material between each battery cell stack and the annular frame surrounding that battery cell stack, wherein the encapsulating material is ionically and electronically insulating.

18. A battery cell constraint system, comprising:
a plurality of battery cell stacks arranged in a vertical stack;
an annular frame that surrounds the vertical stack;
a first endplate positioned over a first face of the vertical stack;
a second endplate positioned over a second face of the vertical stack, the first face opposing the second face;
a first chamber filled with hydraulic fluid between the first endplate and a first flexible membrane above the first face of the vertical stack; and
a second chamber filled with hydraulic fluid between the second endplate and a second flexible membrane above the second face of the vertical stack.

19. The system of 18, wherein the battery cell stacks in the vertical stack are separated from each other by an insulating material.

20. The system of claim 18, wherein the battery cell stacks in the vertical stack are connected electrically in parallel.
